(19) United States
(12) Patent Application Publication
(10) Pub. No.: US 2019/0179563 A1
(43) Pub. Date: Jun. 13, 2019

(54) MEMORY SYSTEM AND OPERATION METHOD THEREOF

(71) Applicant: SK hynix Inc., Gyeonggi-do (KR)

(72) Inventors: Jong-Min LEE, Seoul (KR); Jang-Hyun KIM, Gyeonggi-do (KR)

(21) Appl. No.: 16/020,010

(22) Filed: Jun. 27, 2018

(30) Foreign Application Priority Data
Dec. 8, 2017 (KR) 10-2017-0168343

(51) Int. Cl. G06F 3/06

(52) U.S. Cl. CPC G06F 3/0652; G06F 3/0604; G06F 3/0673; G06F 3/0653; G06F 3/064

(57) ABSTRACT

A method for operating a memory system having a superblock that includes a plurality of physical blocks, each associated with an access frequency number identifying the number of times the corresponding physical block has been accessed, the method includes: updating the largest access frequency number among the access frequency numbers of the plurality of physic& blocks, as a number of times that the superblock is accessed, which is referred to as a superblock access frequency number; and performing a read reclaim operation on the superblock based on the superblock access frequency number.

### CROSS-REFERENCE TO RELATED APPLICATION(S)

The present application claims priority of Korean Patent Application No. 10-2017-0168343, filed on Dec. 8, 2017, which is incorporated herein by reference in its entirety.

### BACKGROUND

### 1. Field

Embodiments of the present invention generally relate to a memory system. Particularly, the embodiments relate to a memory system capable of processing data by using a memory device, and a method for operating the memory system.

### 2. Description of the Related Art

The computer environment paradigm has shifted to ubiquitous computing systems that can be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Memory systems may provide excellent stability, durability, high information access speed, and low power consumption since they have no moving parts, as compared with a hard disk device. Examples of memory systems having such advantages include universal serial bus (USB) memory devices, memory cards having various interfaces, and solid state drives (SSD).

### SUMMARY

Embodiments of the present invention are directed to a method for operating a memory system for reducing an unnecessary read reclaim operation in the memory system, and the memory system.

In accordance with an embodiment of the present invention, a method for operating a memory system having a superblock that includes a plurality of physical blocks, each associated with an access frequency number identifying the number of times the corresponding physical block has been accessed, the method includes: updating the largest access frequency number, among the access frequency numbers of the plurality of physical blocks, as a number of times that the superblock is accessed, which is referred to as a superblock access frequency number; and performing a read reclaim operation on the superblock based on the superblock access frequency number.

The updating of the largest access frequency number may be performed when accessing the superblock is finished.

The updating of the largest access frequency number may be performed when a read count of a physical block access counter exceeds a set value.

The updating of the largest access frequency number may be performed when the read reclaim operation is performed.

The updating of the largest access frequency number may be performed when a check-pointing frequency number exceeds a threshold value.

The updating of the largest access frequency number may be performed when a number of times that the memory system is accessed, which is referred to as a memory system access frequency number, exceeds a set frequency number.

In the updating of the largest access frequency number, the largest access frequency number may be added to the superblock access frequency number.

In accordance with an embodiment of the present invention, a memory system includes: a memory device suitable for storing data, the memory device having a superblock that includes a plurality of physical blocks, each associated with an access frequency number identifying the number of times the corresponding physical block has been accessed; and a controller suitable for controlling the memory device, wherein the controller updates the largest access frequency number among the access frequency numbers of the plurality of physical blocks as a number of times that the superblock is accessed, which is referred to as a superblock access frequency number; and performs a read reclaim operation on the superblock based on the superblock access frequency number.

The controller may perform the updating of the largest access frequency number when accessing the superblock is finished.

The controller may perform the updating of the largest access frequency number when a read count of a physical block access counter exceeds a set value.

The controller may perform the updating of the largest access frequency number when the read reclaim operation is performed.

The controller may perform the updating of the largest access frequency number when a check-pointing frequency number exceeds a threshold value.

The controller may perform the updating of the largest access frequency number when a number of times that the memory system is accessed, which is referred to as a memory system access frequency number, exceeds a set frequency number.

In the updating of the largest access frequency number, the controller may add the largest access frequency number to the superblock access frequency number.

In accordance with an embodiment of the present invention, a memory system, comprising: a memory device, including at least one superblock, each including plural physical blocks, each associated with an access frequency number identifying the number of times the corresponding physical block has been accessed; and a controller electrically coupled with the memory device, wherein the controller is configured to determine which one of access frequency numbers of the plural physical blocks in the superblock is the largest, assign the largest access frequency number as a superblock access frequency number, and perform a read reclaim operation on the superblock according to the superblock access frequency number.

### BRIEF DESCRIPTION OF THE DRAWINGS

FIG. 1 is a block diagram illustrating a data processing system in accordance with an embodiment of the present invention.

FIG. 2 is a schematic diagram illustrating an exemplary configuration of a memory device employed in a memory system of FIG. 1.

FIG. 3 is a circuit diagram illustrating an exemplary configuration of a memory cell array of a memory block in a memory device shown in FIG. 1.

FIG. 4 is a schematic diagram illustrating an exemplary three-dimensional structure of the memory device shown in FIG. 2.

FIG. 5 is a flowchart describing an operation according to a read command in accordance with an embodiment of the present invention.

FIG. 6 illustrates an exemplary structure of a superblock in the memory device shown in FIG. 2.

FIG. 7 is a flowchart describing an operation according to a read command when the memory device is managed on the basis of a superblock in accordance with an embodiment of the present invention.

FIG. 8 illustrates a controller in accordance with an embodiment of the present invention.

FIG. 9 illustrates an operation of a superblock access counter and an operation of a physical block access counter in the memory system of FIG. 8 in accordance with an embodiment of the present invention.

FIGS. 10A to 10D illustrate an update method of a superblock read counter in accordance with an embodiment of the present invention.

### DETAILED DESCRIPTION

Various embodiments of the present invention will be described below in more detail with reference to the accompanying drawings. The present invention may, however, be embodied in different forms and thus is not limited to the embodiments set forth herein. Rather, these embodiments are provided so that this disclosure is thorough and complete and fully conveys the scope of the present invention to those skilled in the art. Throughout the disclosure, like reference numerals refer to like parts throughout the various figures and embodiments of the present invention. Also, throughout the disclosure, reference to “an embodiment” or the like is not necessarily to only one embodiment, and different references to “an embodiment” or the like are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element described below could also be termed as a second or third element without departing from the spirit and scope of the present invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via one or more intervening elements. In addition, it will also be understood that when an element is referred to as being “between” two elements, it may be the only element between the two elements, or one or more intervening elements may also be present.

The terminology used herein is for the purpose of describing particular embodiments and is not intended to be limiting of the present invention.

As used herein, singular forms are intended to include the plural forms and vice versa, unless the context clearly indicates otherwise.

It will be further understood that the terms “comprises,” “comprising,” “includes,” and “including” when used in this specification, specify the presence of the stated elements but do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention pertains in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

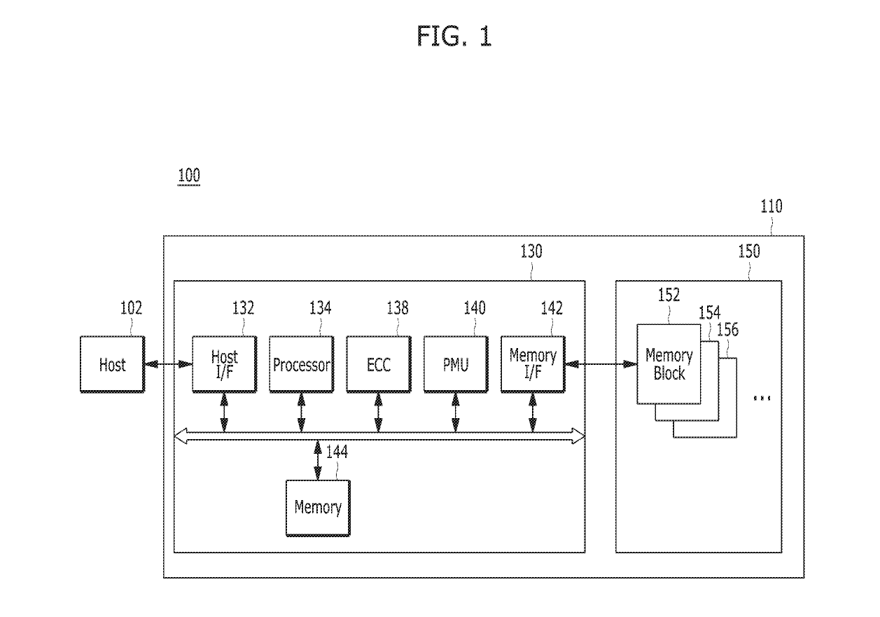

FIG. 1 is a block diagram illustrating a data processing system 100 in accordance with an embodiment of the present invention.

Referring to FIG. 1, the data processing system 100 may include a host 102 operatively coupled to a memory system 110.

By way of example but not limitation, the host 102 may include portable electronic devices such as a mobile phone, MP3 player, and laptop computer or non-portable electronic devices such as a desktop computer, a game machine, a TV and a projector.

The host 102 may include at least one operating system (OS). The OS may manage and control overall functions and operations of the host 102. The OS may also support an operation between the host 102 and a user, which may be achieved or implemented by the data processing system 100 or the memory system 110. The OS may support functions and operations requested by a user. For example, the OS may be divided into a general OS and a mobile OS, depending on whether it is customized for the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS configured to support a customized function of providing a mobile service to users and a power saving function of a system may include Android, iOS and Windows Mobile. At this time, the host 102 may include a plurality of OSs, and execute an OS to perform an operation corresponding to a user's request on the memory system 110.

The memory system 110 may operate to store data for the host 102 in response to a request of the host 102. Non-limiting examples of the memory system 110 may include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card, and a memory stick. The MMC may include an embedded MMC (eMMC), a reduced size MMC (RS-MMC) and a micro-MMC, and the like. The SD card may include a mini-SD card and micro-SD card.

The memory system 110 may be embodied by various types of storage devices. Non-limited examples of storage devices included in the memory system 110 may include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM) and a flash memory. The flash memory may have a 3-dimensional (3D) stack structure.

The memory system 110 may include a memory device 150 and a controller 130. The memory device 150 may store data for the host 102, and the controller 130 may control data storage into the memory device 150.

The controller 130 and the memory device 150 may be integrated into a single semiconductor device, which may be included in the various types of memory systems as described above. For example, the controller 130 and the memory device 150 may be integrated as a single semiconductor device to constitute an SSD. When the memory system 110 is used as an SSD, the operating speed of the host 102 connected to the memory system 110 can be improved. In addition, the controller 130 and the memory device 150 may be is integrated as a single semiconductor device to constitute a memory card of any of a variety of forms such as a PCMCIA (personal computer memory card international association) card, a CF card, a SMC (smart media card), a memory stick, an MMC including an RS-MMC and a micro-MMC, a SD card including a mini-SD, a micro-SD and a SDHC, an UFS device, and the like.

The memory system 110 may be available for a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device which may retain data stored therein even though power is not supplied. The memory device 150 may store data provided from the host 102 through a write operation, while outputting data stored therein to the host 102 through a read operation. The memory device 150 may include a plurality of memory blocks 152, 154, 156 . . . (hereinafter, referred to as “memory blocks 152 to 156”) each of which may include a plurality of pages, and each of the pages may include a plurality of memory cells coupled to a word line. In an embodiment, the memory device 150 may be a flash memory. The flash memory may have a 3-dimensional (3D) stack structure.

The controller 130 may control the memory device 150 in response to a request from the host 102. For example, the controller 130 may provide data read from the memory device 150 to the host 102, and store data provided from the host 102 into the memory device 150. For these operations, the controller 130 may control read, write, program and erase operations of the memory device 150.

The controller 130 may include a host interface (I/F) 132, a controller processor 134, an error correction code (ECC) component 138, a Power Management Unit (PMU) 140, a memory interface (I/F) 142 such as a NAND flash controller (NFC), and a controller memory 144 operatively coupled with each other via an internal bus.

The host interface 132 may be configured to process a command and data of the host 102. The host interface 132 may communicate with the host 102 according to one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI) and integrated drive electronics (IDE).

The ECC component 138 may detect and correct an error contained in the data read from the memory device 150. In other words, the ECC component 138 may perform an error correction decoding process on the data, read from the memory device 150, using an ECC code. The ECC code may be formed from serial mathematic polynomial terms combined together to encode and decode specific covered data. According to a result of the error correction decoding process, the ECC component 138 may output a signal, for example, an error correction success or fail signal. When the number of error bits is more than a threshold value of correctable error bits, the ECC component 138 may not correct the error bits, and may instead output the error correction fail signal.

The ECC component 138 may perform error correction through a coded modulation such as Low Density Parity Check (LDPC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC component 138 is not limited to these correction techniques. As such, the ECC component 138 may include all circuits, modules, systems or devices for error correction.

The PMU 140 may manage electrical power used and provided in the controller 130.

The memory interface 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the memory interface 142 may generate a control signal for the memory device 150 and process data, which is transmitted to the memory device 150, under the control of the controller processor 134. The memory interface 142 may work as an interface (e.g., a NAND flash interface) for processing a command and data between the controller 130 and the memory device 150. Specifically, the memory interface 142 may support data transfer between the controller 130 and the memory device 150.

The controller memory 144 may serve as a working memory of the memory system 110 and the controller 130. The controller memory 144 may store data supporting operations of the memory system 110 and the controller 130. The controller 130 may control the memory device 150 to perform read, write, program, and erase operations in response to a request from the host 102. The controller 130 may output data, read from the memory device 150, to the host 102, and may store data provided from the host 102 into the memory device 150. The controller memory 144 may store data required for the controller 130 and the memory device 150 to perform these operations.

The controller memory 144 may be embodied by a volatile memory. For example, the controller memory 144 may be embodied by a static random access memory (SRAM) or a dynamic random access memory (DRAM). The controller memory 144 may be disposed within or externally to the controller 130. FIG. 1 illustrates an embodiment of the controller memory 144 disposed within the controller 130. In another embodiment, the controller memory 144 may be embodied by an external volatile memory having a memory interface transferring data between the controller memory 144 and the controller 130.

The controller processor 134 may control the overall operations of the memory system 110. The controller processor 134 may use firmware to control overall operations of the memory system 110. The firmware may be referred to as a flash translation layer (FTL). Also, the controller processor 134 may be realized as a microprocessor or a Central Processing Unit (CPU).

By the way of example but not limitation, the controller 130 may perform an operation requested by the host 102 in the memory device 150 through the controller processor 134. In other words, the controller 130 may perform a command operation corresponding to a command received from the host 102. Herein, the controller 130 may perform a foreground operation as the command operation corresponding to the command received from the host 102. By the way of example but not limitation, the controller 130 may perform at least one of a program operation corresponding to a write command, a read operation corresponding to a read command, an erase operation corresponding to an erase command, and a parameter set operation corresponding to a set parameter command or a set feature command as a set command.

Also, the controller 130 may perform a background operation on the memory device 150 through the controller processor 134. Herein, the background operation performed on the memory device 150 may include a garbage collection (GC) operation, a wear-leveling (WL) operation, a map flush operation, a bad block management operation and the like. The garbage collection is a type of operation for copying and processing data stored in some memory blocks, among the memory blocks 152 to 156 of the memory device 150, into other memory blocks. The wear-leveling (WL) operation is a kind of operation for performing swapping between the memory blocks 152 to 156 or between the data of the memory blocks 152 to 156. The map flush operation is for storing the map data stored in the controller 130 in the memory blocks 152 to 156. The bad block management operation is for managing bad blocks of the memory device 150, e.g., detecting and processing bad blocks among the memory blocks 152 to 156.

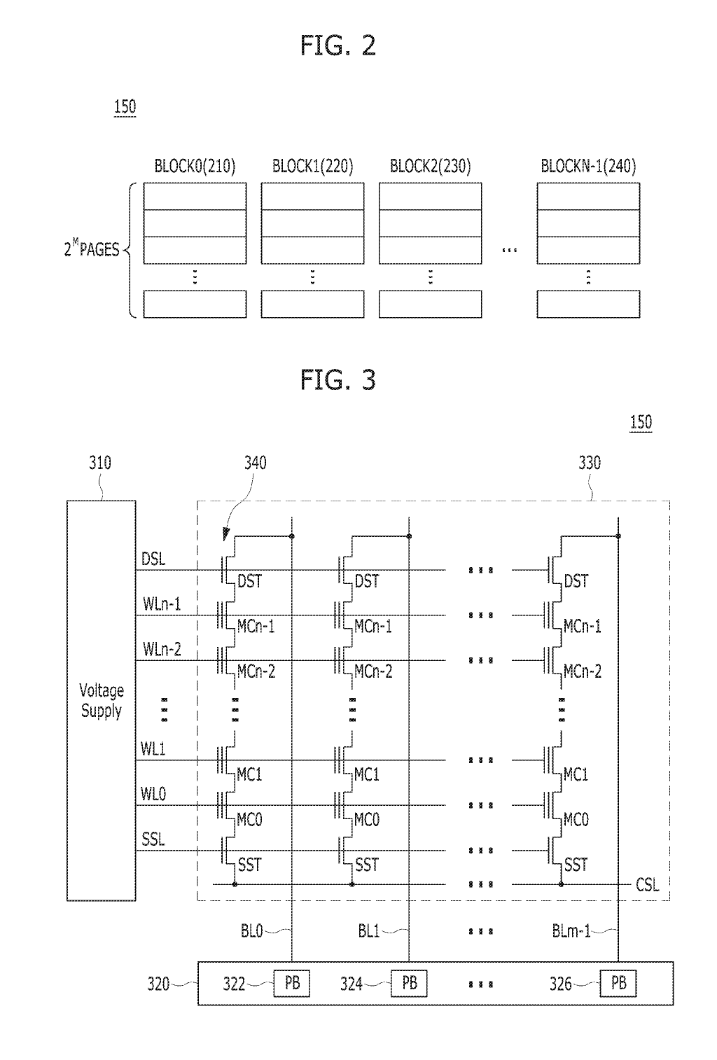

The processor 134 of the controller 130 may include a management unit (not illustrated) for performing a bad management operation of the memory device 150. The management unit may perform a bad block management operation of checking a bad block, in which a program fail occurs due to a characteristic of the memory device, for example, a NAND flash memory during a program operation, among the plurality of memory blocks 152 to 156 included in the memory device 150. The management unit may write the program-failed data of the bad block to a new memory block. In a memory device 150 having a 3D stack structure, the bad block management operation may reduce the use efficiency of the memory device 150 and the reliability of the memory system 110. Thus, the bad block management operation needs to be performed with more reliability. Hereafter, the memory device of the memory system in accordance with an embodiment of the present invention is described in detail with reference to FIGS. 2 to 4.

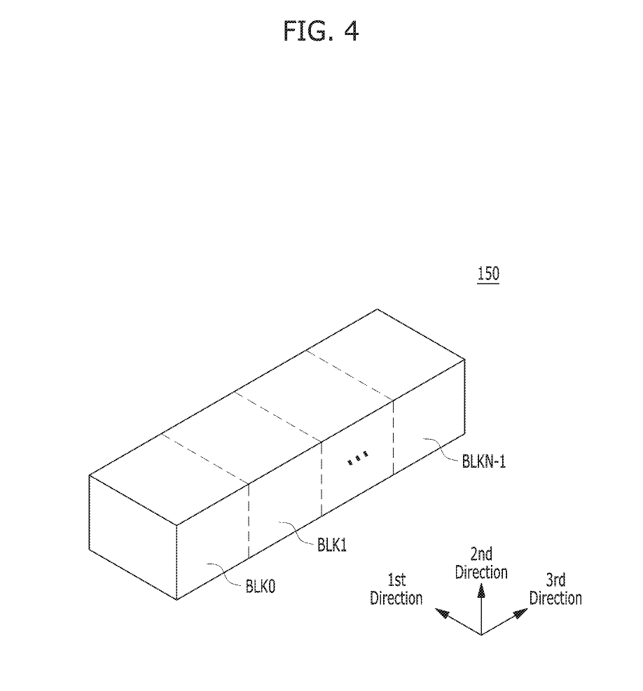

FIG. 2 is a schematic diagram illustrating the memory device 150. FIG. 3 is a circuit diagram illustrating an exemplary configuration of a memory cell array of a memory block in the memory device 150. FIG. 4 is a schematic diagram illustrating an exemplary 3D structure of the memory device 150.

Referring to FIG. 2, the memory device 150 may include a plurality of memory blocks 0 to N-1, e.g., a memory block 0 BLOCK0 (210), a memory block 1 BLOCK1 (220), a memory block 2 BLOCK2 (230), and a memory block N-1 BLOCKN-1 (240). Each of the memory blocks 0 to N-1 may include a plurality of pages, for example, 2^{M} pages, the number of which may vary according to circuit design. For example, instead of 2^{M}pages, each of the memory blocks may include M pages. Each of the pages may include a plurality of memory cells that are coupled to a plurality of word lines WL.

Also, the plurality of memory blocks may include a single level cell (SLC) memory block storing 1-bit data and/or a multi-level cell

(MLC) memory block storing 2-bit data. Herein, the SLC memory blocks may include a plurality of pages that are realized by memory cells storing one-bit data in one memory cell. The SLC memory blocks may have a quick data operation performance and high durability. On the other hand, the MLC memory blocks may include a plurality of pages that are realized by memory cells storing multi-bit data, e.g., data of two or more bits, in one memory cell. The MLC memory blocks may have a greater data storing space than the SLC memory blocks. In other words, the MLC memory blocks may be highly integrated. Particularly, the memory device 150 may include, not only the MLC memory blocks each of which includes a plurality of pages that are realized by memory cells capable of storing two-bit data in one memory cell, but also triple level cell (TLC) memory blocks each of which includes a plurality of pages that are realized by memory cells capable of storing three-bit data in one memory cell, quadruple level cell (QLC) memory blocks each of which includes a plurality of pages that are realized by memory cells capable of storing four-bit data in one memory cell, and/or multiple level cell memory blocks each of which includes a plurality of pages that are realized by memory cells capable of storing five or more-bit data in one memory cell, and the like.

Although the memory device 150 is primarily described herein as a non-volatile memory, such as a flash memory, e.g., a NAND flash memory, the memory device 150 also may be realized as one memory among a Phase Change Random Access Memory (PCRAM), a Resistive Random Access Memory (RRAM or ReRAM), a Ferroelectric Random Access Memory (FRAM), a Spin Transfer Torque Magnetic Random Access Memory (STT-RAM or STT-MRAM).

The memory blocks 0 to N-1 may store the data transferred from the host 102 through a program operation, and transfer data stored therein to the host 102 through a read operation.

Referring to FIG. 3, a memory block 330, which may correspond to any of the plurality of memory blocks 152 to 156 in the memory device 150 of the memory system 110, may include a plurality of cell strings 340 coupled to a plurality of corresponding bit lines BL0 to BLm-1. The cell string 340 of each column may include one or more drain select transistors DST and one or more ground select transistors GST. Between the drain and select transistors DST, GST, a plurality of memory cells MC0 to MCn-1 may be coupled in series. In an embodiment, each of the memory cell transistors MC0 to MCn-1 may be embodied by an MLC capable of storing data information of a plurality of bits. Each of the cell strings 340 may be electrically coupled to a corresponding bit line among the plurality of bit lines BL0 to BLm-1. For example, as illustrated in FIG. 3, the first cell string is coupled to the first bit line BL0, and the last cell string is coupled to the last bit line BLm-1.

Although FIG. 3 illustrates NAND flash memory cells, the invention is not limited in this way. It is noted that the memory cells may include NOR flash memory cells, or hybrid flash memory cells including two or more types of memory cells combined therein. Also, it is noted that the memory device 150 may include a flash memory device including a conductive floating gate as a charge storage layer or a charge trap flash (CTF) memory device including an insulation layer as a charge storage layer.

The memory device 150 may further include a voltage supply 310 which provides word line voltages including a program voltage, a read voltage and a pass voltage to supply to the word lines according to an operation mode. The voltage generation operation of the voltage supply 310 may be controlled by a control circuit (not illustrated). Under the control of the control circuit, the voltage supply 310 may select at least one of the memory blocks (or sectors) of the memory cell array, select at least one of the word lines of the selected memory block, and provide the word line voltages to the selected word line and the unselected word lines as may be needed.

The memory device 150 may include a read/write circuit 320 which is controlled by the control circuit. During a verification or a normal read operation, the read/write circuit 320 may operate as a sense amplifier for reading data from the memory cell array. During a program operation, the read/write circuit 320 may operate as a write driver for supplying a voltage or a current to bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

The memory device 150 may be embodied by a 2D or 3D memory device. Particularly, as illustrated in FIG. 4, the memory device 150 may be embodied by a nonvolatile memory device having a 3D stack structure. Having a 3D structure, the memory device 150 may include a plurality of memory blocks BLK0 to BLKN-1. Herein, FIG. 4 is a block diagram illustrating the memory blocks 152 to 156 of the memory device 150 shown in FIG. 1. Each of the memory blocks 152 to 156 may be realized in a 3D structure (or vertical structure). For example, the memory blocks 152 to 156 may include structures having dimensions extending in first to third orthogonal directions, e.g., an x-axis direction, a y-axis direction, and a z-axis direction.

Each memory block 330 in the memory device 150 may include a plurality of NAND strings NS extending in the second direction, and a plurality of NAND strings NS extending in the first direction and the third direction. Each of the NAND strings NS may be coupled to a bit line BL, at least one string selection line SSL (not shown), at least one ground selection line GSL, a plurality of word lines WL, at least one dummy word line DWL, and a common source line CSL. Each of the NAND strings NS may include a plurality of transistor structures TS.

In short, each memory block 330 among the memory blocks 152 to 156 of the memory device 150 may be coupled to a plurality of bit lines BL, a plurality of string selection lines SSL, a plurality of ground selection lines GSL, a plurality of word lines WL, a plurality of dummy word lines DWL, and a plurality of common source lines CSL. Each memory block 330 may include a plurality of NAND strings NS. Also, in each memory block 330, a single bit line BL may be coupled to a plurality of NAND strings NS, each including a plurality of transistors. Also, a string selection transistor SST of each NAND string NS may be coupled to a corresponding bit line BL, while a ground selection transistor GST of each NAND string NS may be coupled to a common source line CSL. Herein, memory cells MC may be arranged between the string selection transistor SST and the ground selection transistor GST of each NAND string NS. In other words, a plurality of memory cells may be included in each memory block 330 of the memory device 150.

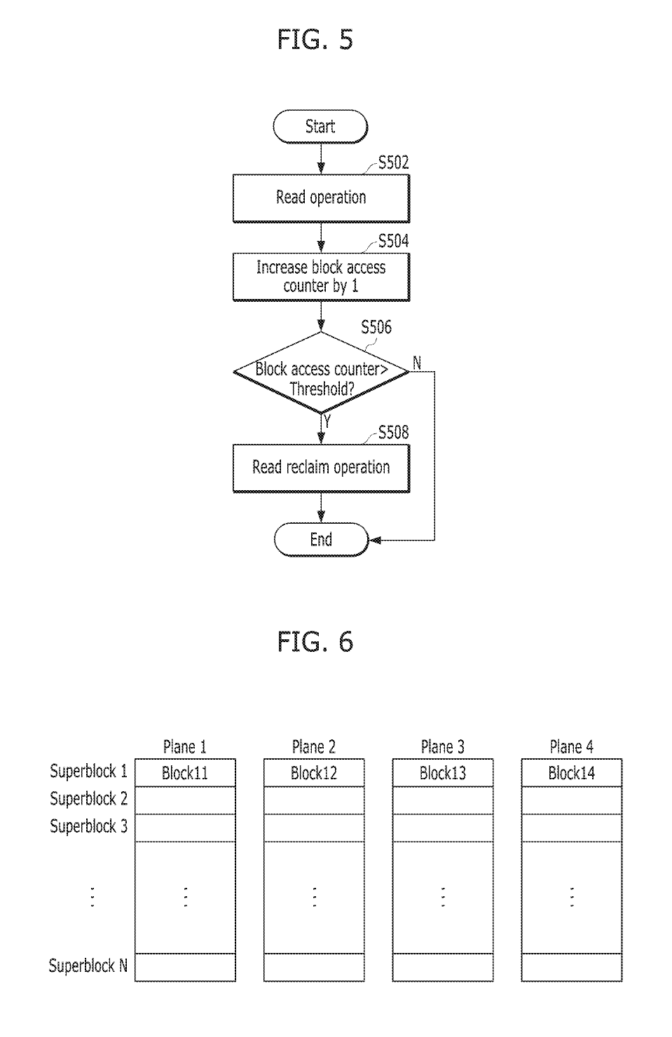

An operation of a memory system 110 in accordance with an embodiment of the present invention is described by referring to FIGS. 5 to 10D.

Since a pass voltage is applied to word lines that are not selected during a read operation, a disturbance phenomenon may occur in a neighboring memory cell in which its threshold voltage may be affected by the pass voltage. In short, as time passes after a program operation ends, the threshold voltage of a programmed cell may vary, which in turn may cause an error in a subsequent read operation. When the number of error bits is increased, the errors may not be corrected even though an error correction decoding is performed, and a read failure may occur.

An operation of writing data of a memory block into a new memory block, before it becomes impossible to correct an error even through an error correction decoding operation, to prevent a read failure from occurring due to repeated read operations may be referred to as a read reclaim operation.

For example, when read operations are performed onto a predetermined memory block more than a predetermined number of times, it may be regarded that a read failure is likely to occur and the read reclaim operation regarding the predetermined memory block may be performed.

FIG. 5 is a flowchart describing an operation according to a read command in accordance with an embodiment of the present invention.

When the controller 130 receives a read command from the host 102, an operation of reading a memory block 330 may be performed in step S502. In step S504, the controller 130 may increase a block access counter of the memory block 330 by ‘1’. In step S506, the controller 130 may determine whether the block access counter exceeds a predetermined or set threshold value. When the block access counter exceeds the predetermined threshold value (‘Y’ in the step S506), the controller 130 may perform a read reclaim operation in step S508. When the block access counter does not exceed the predetermined threshold value (‘N’ in the step S506), the controller 130 may not perform a read reclaim operation, but end the operation according to the read command.

FIG. 6 illustrates an exemplary structure of a superblock in the memory device shown in FIG. 2.

The superblock may be a logical block formed of physical blocks that are positioned on different planes. Since each of the physical blocks of the superblock exists on a different plane, there is an advantage in that the physical blocks may be accessed simultaneously.

Referring to FIG. 6, superblocks 1 to N may be a logical block formed of physical blocks that exist on four planes. For example, the superblock 1 may include a block 11, a block 12, a block 13, and a block 14, which are physical blocks.

When the memory system 110 manages the memory block 330 as superblocks, the read reclaim operation may be performed on the basis of a superblock,

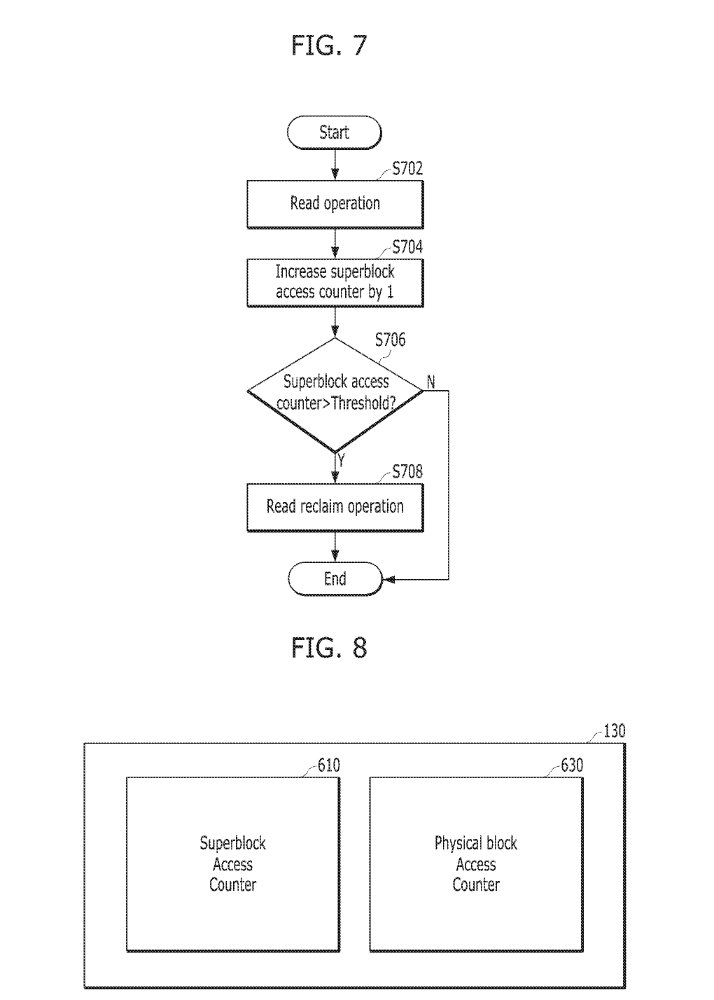

FIG. 7 is a flowchart describing an operation according to a read command when the memory device 150 is managed on the basis of a superblock in accordance with an embodiment of the present invention.

The controller 130 may perform a superblock read operation in response to a read command in step S702. The controller 130 may increase a superblock access counter by ‘1’ in step S704. In step S706, the controller 130 may determine whether the superblock access counter exceeds a predetermined or set threshold value. When the superblock access counter exceeds the predetermined threshold value (‘Y’ in the step S706), the controller 130 may perform a read reclaim operation on the superblock. When the superblock access counter does not exceed the predetermined threshold value (‘N’ in the step S708), the controller 130 may not perform the read reclaim operation but end an operation according to the read command.

When a read reclaim operation is performed based on a count of the number of times that a read operation is performed on a specific superblock, it is likely that such read reclaim operation is performed unnecessarily frequently. This is because the superblock access counter does not accurately reflect the number of times that each of plurality of physical blocks in the single superblock is accessed.

For example, when the number of times that a read operation is performed for the superblock 1 is approximately 100, the read count in each of the block 11, the block 12, the block 13, and the block 14 may be 25. In this case, even though the read count for each of the physical blocks is not high enough to perform a read reclaim operation (25 may be less than a threshold), the read reclaim operation may be performed unnecessarily if it is determined that the read count for the superblock is high (100 may be over the threshold), thus decreasing the performance of the memory system 110.

An embodiment of the present invention may provide a method for increasing the performance of the memory system 110 by reflecting the number of times that a read operation is performed for each of the physical blocks in one superblock in the superblock access counter and thus decreasing performance of unnecessary read reclaim operations.

FIG. 8 illustrates the controller 130 in accordance with an embodiment of the present invention.

The controller 130 may further include a superblock access counter 610 and a physical block access counter 630. The superblock access counter 610 and the physical block access counter 630 may operate under the control of the processor 134. The superblock access counter 610 may manage the number of times that a read operation is performed for a superblock to initiate a read reclaim operation. The physical block access counter 630 may reflect the actual number of times that a read operation is performed for each of the physical blocks into the superblock access counter 610.

The superblock access counter 610 and the physical block access counter 630 may be included in the memory 144 of the controller 130 of FIG. 1. In another example, the superblock access counter 610 and the physical block access counter 630 may be separate from other constituent elements.

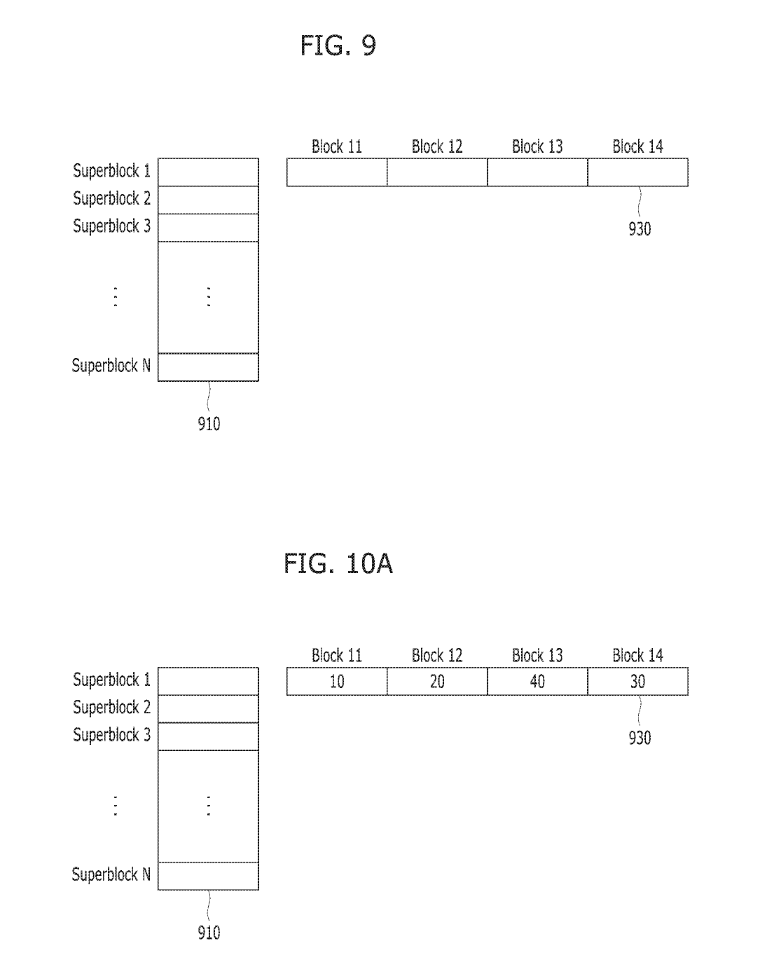

FIG. 9 illustrates an operation of the superblock access counter 610 and an operation of the physical block access counter 630 in the memory system of FIG. 8 in accordance with an embodiment of the present invention.

The physical block access counter 630 may manage the read count of each of the physical blocks in a superblock that is recently accessed. For example, if the superblock is formed of physical blocks, each of which is on one of four planes, the physical block access counter 630 may include a cache 910 of an array structure that has the address of each superblock as an index. Also, the physical block access counter 630 may include a cache 930 of an array structure that has the address of each of the physical blocks included in the recently accessed superblock as an index. The physical block access counter 630 may count the number of times that a read operation is performed for each of the physical blocks in the superblock while the superblock is accessed. When a predetermined event occurs, the superblock access counter 610 may update the superblock access counter cache 910 to the largest number of times that a read operation is performed, which is referred to as a largest physical block read frequency number, among the physical block read frequency numbers for the respective physical blocks, as the number of times that a read operation is performed for the superblock, which is referred to as a superblock read frequency number. The update may mean adding the largest physical block read frequency number to the superblock read frequency number which is stored in the superblock access counter cache 910.

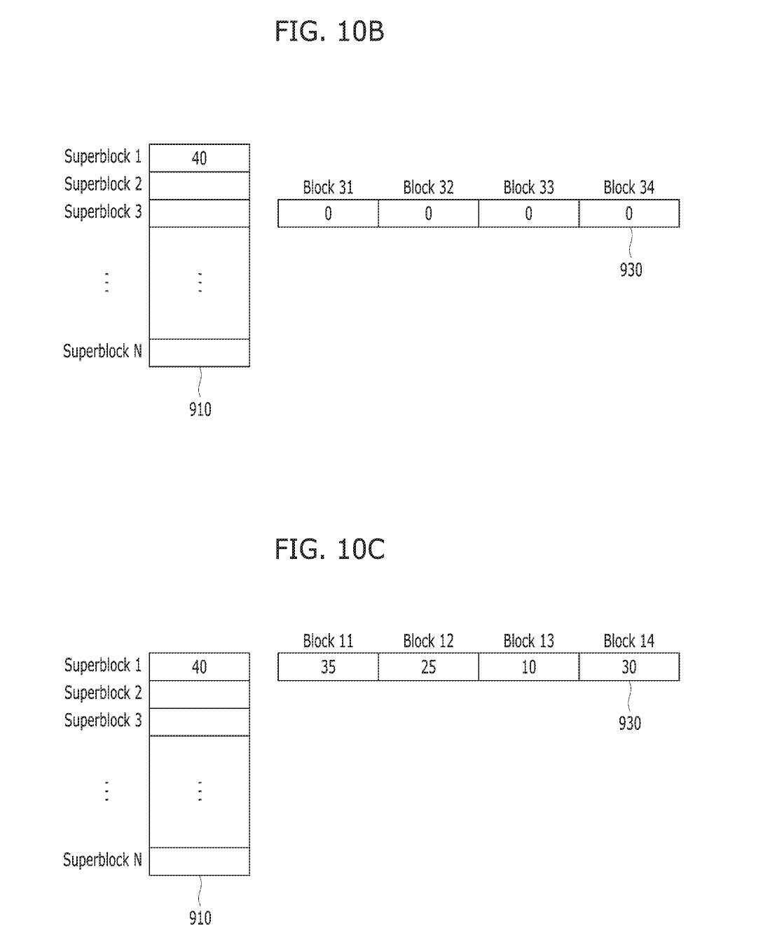

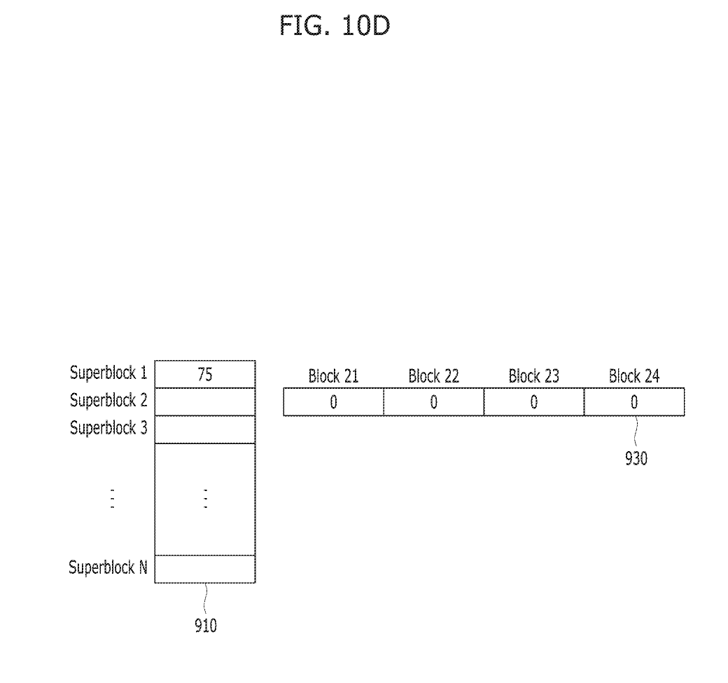

FIGS. 10A to 10D illustrates an update method of a superblock read counter in accordance with an embodiment of the present invention.

Referring to FIG. 10A, the physical block access counter 630 may count the number of times that a read operation is performed for each of the blocks 11, 12, 13, and 14 in the physical block access counter cache 930, while accessing the superblock 1 individually.

FIG. 10B illustrates a case in which the controller 130 accesses the superblock 3 after finishing accessing the superblock 1. The physical block access counter cache 930 may be initialized to count the number of times that a read operation is performed for each of blocks 31, 32, 33, and 34 of the superblock 3. The superblock access counter 610 may update the superblock access counter cache 910 with the largest physical block read frequency number (which is ‘40’), among the physical block read frequency numbers for the respective blocks 11, 12, 13 and 14 that are counted in the physical block access counter cache 930, as the number of times that a read operation is performed for the superblock 1, which is referred to as a superblock read frequency number for the superblock 1.

FIG. 10C illustrates a case in which the controller 130 accesses the superblock 1 again after finishing accessing the superblock 3. The physical block access counter cache 930 may be initialized again, and then the physical block access counter 630 may count the number of times that a read operation is performed for each of the block 11, the block 12, the block 13 and the block 14 in the physical block access counter cache 930, while accessing the superblock 1.

FIG. 10D illustrates a case in which the controller 130 accesses the superblock 2 after finishing accessing the superblock 1. The controller 130 may update the superblock access counter cache 910 with the largest physical block read frequency number (which is ‘35’), among the numbers of times that read operations are performed for the respective physical blocks and counted in the physical block access counter cache 930, as the superblock read frequency number for the superblock 1, when accessing the superblock 2. For example, the number of times that a read operation is performed for the superblock 1 that is stored in the superblock access counter cache 910 in FIG. 10D is ‘75’.

In the cases of FIGS. 10A to 10D, the total numbers of times that a read operation is performed for the block 11, the block 12, the block 13 and the block 14 are 45, 45, 50, and 60, respectively. According to the prior art, the superblock access count of the superblock 1 is 200.

However, the superblock access count of the superblock 1 is 75 in accordance with an embodiment of the present invention. Therefore, since the read reclaim operation is not performed unnecessarily frequently, according to an embodiment of the present invention, the performance of the memory system 110 may be improved.

According to an embodiment of the present invention, when one among the physical block read frequency numbers of the physical blocks stored in the physical block access counter cache 930 exceeds a predetermined or set threshold value, the superblock access counter 610 may update the superblock access counter cache 910 with the largest physical block read frequency number among those numbers as the superblock read frequency number for the particular superblock. The predetermined threshold value may be the maximum value among the values assigned to the physical blocks in the physical block access counter cache 930. For example, if the number of bits assigned to each physical block is N (i.e., N bits), the superblock access counter 610 may perform an update operation when the number of times that a read operation is performed for the physical blocks is counted to be 2^{N}−1. The predetermined threshold value may be a value smaller than the maximum value. When the superblock access counter 610 performs the update operation, the physical block access counter 630 may initialize the physical block access counter cache 930.

Since the read reclaim operation is performed in the background of a foreground operation, the foreground operation may be performed on the superblock while the read reclaim operation is performed on the superblock. If a read operation continues to be performed on the superblock while the read reclaim operation is performed, a disturbance phenomenon may be accelerated. Therefore, the read reclaim operation may have to be performed rapidly.

According to an embodiment of the present invention, when a read reclaim operation is performed on a particular superblock, the superblock access counter 610 may update the superblock access counter cache 910 with the largest physical block read frequency number, among the physical block read frequency numbers for the respective physical blocks in the particular superblock, which are stored in the physical block access counter, as the superblock read frequency number for the particular superblock. The physical block access counter 630 may initialize the physical block access counter cache 930.

The memory system 110 may perform a check-pointing operation of storing the operation state of the controller 130 in the memory device 150. When a failure occurs in the memory system 110, the memory system 110 may resume the operation not from the starting point but from the most recently registered check-point.

According to an embodiment of the present invention, when the number of times that the check-pointing operation is performed exceeds a predetermined or set threshold value, the superblock access counter 610 may update the superblock access counter cache 910 with the largest physical block read frequency number, among such numbers, which are stored in the physical block access counter cache 930, as the superblock read frequency number for the particular superblock. Herein, the physical block access counter 630 may initialize the physical block access counter cache 930.

According to an embodiment of the present invention, whenever the read operation is performed in the memory system 110 a predetermined number of times, the superblock access counter 610 may update the superblock access counter cache 910 with the largest physical block read frequency number among such numbers, which are stored in the physical block access counter cache 930, as the superblock read frequency number. The physical block access counter 630 may initialize the physical block access counter cache 930.

If the numbers of times that a read operation is performed for the physical blocks in the superblock are counted using the physical block access counter 630 and, a predetermined event occurs in accordance with an embodiment of the present invention, the largest physical block read frequency number, among such numbers, is counted using the superblock access counter 610, it is possible to prevent a read reclaim operation from being performed unnecessarily frequently and thereby improve the performance of the memory system 110, as described above with reference to FIGS. 10A to 10D.

According to embodiments of the present invention, a method for operating a memory system for reducing an unnecessary read reclaim operation in the memory system, and the memory system are provided.

While the present invention has been described with respect to the specific embodiments, it will be apparent to those skilled in the art, in light of the present disclosure, that various changes and modifications may be made without departing from the spirit and scope of the invention as defined in the following claims.

What is claimed is:

1. A method for operating a memory system having a superblock that includes a plurality of physical blocks, each associated with an access frequency number identifying the number of times the corresponding physical block has been accessed, the method comprising:
updating the largest access frequency number, among the access frequency numbers of the plurality of physical blocks, as a number of times that the superblock is accessed, which is referred to as a superblock access frequency number; and
performing a read reclaim operation on the superblock based on the superblock access frequency number.

2. The method of claim 1, wherein the updating of the largest access frequency number is performed when accessing the superblock is finished.

3. The method of claim 1, wherein the updating of the largest access frequency number is performed when a read count of a physical block access counter exceeds a set value.

4. The method of claim 1, wherein the updating of the largest access frequency number is performed when the read reclaim operation is performed.

5. The method of claim 1, wherein the updating of the largest access frequency number is performed when a check-pointing frequency number exceeds a threshold value.

6. The method of claim 1, wherein the updating of the largest access frequency number is performed when a number of times that the memory system is accessed, which is referred to as a memory system access frequency number, exceeds a set frequency number.

7. The method of claim 1, wherein, in the updating of the largest access frequency number,
the largest access frequency number is added to the superblock access frequency number.

8. A memory system, comprising:
a memory device suitable for storing data, the memory device having a superblock that includes a plurality of physical blocks, each associated with an access frequency number identifying the number of times the corresponding physical block has been accessed; and
a controller suitable for controlling the memory device,
wherein the controller updates the largest access frequency number, among the access frequency numbers of the plurality of physical blocks, as a number of times that the superblock is accessed, which is referred to as a superblock access frequency number; and performs a read reclaim operation on the superblock based on the superblock access frequency number.

9. The memory system of claim 8, wherein the controller performs the updating of the largest access frequency number when accessing the superblock is finished.

10. The memory system of claim 8, wherein the controller performs the updating of the largest access frequency number when a read count of a physical block access counter exceeds a set value.

11. The memory system of claim 8, wherein the controller performs the updating of the largest access frequency number when the read reclaim operation is performed.

12. The memory system of claim 8, wherein the controller performs the updating of the largest access frequency number when a check-pointing frequency number exceeds a threshold value.

13. The memory system of claim 8, wherein the controller performs the updating of the largest access frequency number when a number of times that the memory system is accessed, which is referred to as a memory system access frequency number, exceeds a set frequency number.

14. The memory system of claim 8, wherein in the updating of the largest access frequency number,
the controller adds the largest access frequency number to the superblock access frequency number.

15. A memory system, comprising:
a memory device, including at least one superblock, each including plural physical blocks, each associated with an access frequency number identifying the number of times the corresponding physical block has been accessed; and
a controller electrically coupled with the memory device,
wherein the controller is configured to determine which one of access frequency numbers of the plural physical blocks in the superblock is the largest, assign the largest access frequency number as a superblock access frequency number, and perform a read reclaim operation on the superblock according to the superblock access frequency number.
